(19) United States
(12) Patent Application Publication
(10) Pub. No.: US 2025/0282916 A1
(43) Pub. Date: Sep. 11, 2025

(54) COMPOSITION FOR FORMING FOUR OR MORE-FOLD NETWORK STRUCTURE AND SELF-ASSEMBLY NANOSTRUCTURE PREPARED THEREFROM

(71) Applicant: POSTECH RESEARCH AND BUSINESS DEVELOPMENT FOUNDATION, Pohang-si (KR)

(72) Inventors: Moon Jeong PARK, Pohang-si (KR); Hojun LEE, Pohang-si (KR)

(73) Assignee: POSTECH RESEARCH AND BUSINESS DEVELOPMENT FOUNDATION, Pohang-si (KR)

(21) Appl. No.: 19/052,619

(22) Filed: Feb. 13, 2025

(30) Foreign Application Priority Data
Mar. 7, 2024 (KR) 10-2024-0032528

(51) Int. Cl. C08G 81/02; C08F 8/30; C08F 8/40

(52) U.S. Cl. CPC C08G 81/025; C08F 8/30; C08F 8/40

(57) ABSTRACT

Provided are a composition for forming a 4 or more-fold network structure including a block copolymer to the terminal of which a double terminal substituent selected from the following Chemical Formulae 1 and 2 is introduced and a self-assembly nanostructure in a thermodynamically stable state prepared therefrom:

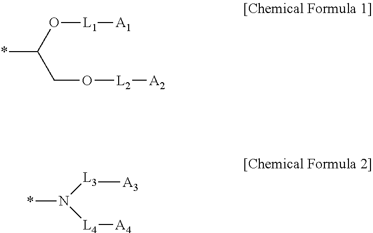

wherein L₁ to L₄, A₁ to A₄, R₁, and R₂ are as defined in the specification.

### CROSS-REFERENCE TO RELATED APPLICATIONS

This application claims priority under 35 U. S. C. § 119 to Korean Patent Application No. 10-2024-0032528, filed on Mar. 7, 2024, in the Korean Intellectual Property Office, the disclosure of which is incorporated herein by reference in its entirety.

### TECHNICAL FIELD

The following disclosure relates to a composition for forming a 4 or more-fold network structure and a self-assembly nanostructure prepared therefrom.

### BACKGROUND

A block copolymer is characterized by forming a microstructure of a nanometer unit by self-assembly by incompatibility between different blocks. A self-assembly phenomenon of a block copolymer as such may form various network structures ranging from a simple structure such as lamella and cylinder to a form in which multiple channels intersect such as gyroid, diamond, and plumber's nightmare (primitive) structures.

In particular, since a network structure in the form in which multiple channels intersect has mechanical and electrical properties which are improved by a double continuous nanodomain, it is in the spotlight as a next-generation high-performance material in a wide range of industrial field. However, it is difficult for the network structure to exist in a thermodynamically stable state, in particular, since the diamond and plumber's nightmare structures in the form in which 4 or more channels intersect exist only theoretically to date, research to develop a block copolymer having a thermodynamically stable network structure continues.

### RELATED ART DOCUMENTS

### Non-Patent Document

Angew. Chem. 2017, 129, 7241-7246

### SUMMARY

An embodiment of the present invention is directed to providing a composition for forming a 4 or more-fold network structure and a self-assembly nanostructure in a thermodynamically stable state prepared therefrom.

Another embodiment of the present invention is directed to providing a method for controlling a self-assembly structure by introducing a double terminal substituent to a block copolymer terminal.

In one general aspect, a composition for forming a 4 or more-fold network structure includes: a block copolymer to the terminal of which a double terminal substituent selected from the following Chemical Formulae 1 and 2 is introduced:

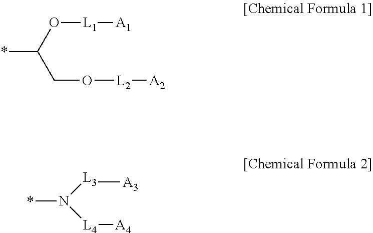

wherein
L₁ to L₄ are independently of one another C1-C7 alkylene;
A₁ to A₄ are independently of one another nitrile or

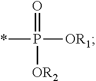

and
R₁ and R₂ are independently of each other hydrogen or
C1-C7 alkyl.
L₁ to L₂ may be independently of each other C1-C4 alkylene, and R₁ and R₂ may be independently of each other hydrogen or C1-C4 alkyl.

The double terminal substituent according to an exemplary embodiment may be selected from the following structures:

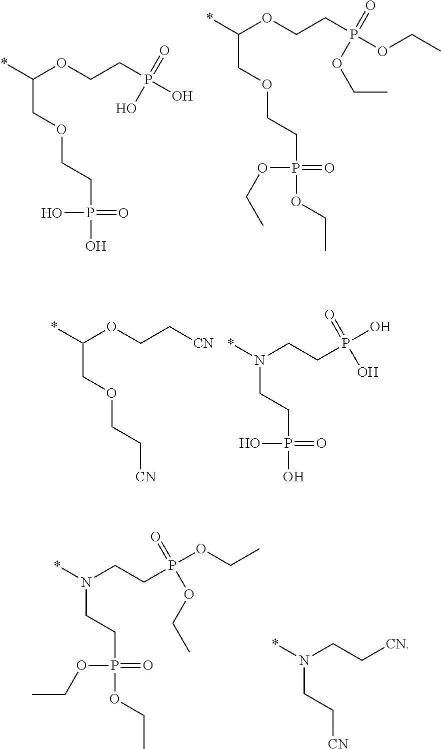

The block copolymer may be a diblock copolymer including a first block having physical properties of glass and a second block having physical properties of rubber.

The block copolymer may be polystyrene-b-polyethylene oxide, polystyrene-b-polymethylbutylene, or polystyrene-b-polydimethylsiloxane.

The block copolymer may have a number average molecular weight of 7.0 to 30.0 kg/mol and each block of the block copolymer may have a number average molecular weight of 3.0 kg/mol or more, respectively.

The 4 or more-fold network structure according to an exemplary embodiment may be selected from a diamond structure (4-fold), a plumber's nightmare structure (6-fold), and an A15 network structure (12,14-fold).

The block copolymer to which the double terminal substituent is introduced according to an exemplary embodiment may be represented by the following Chemical Formulae 3 to 6:

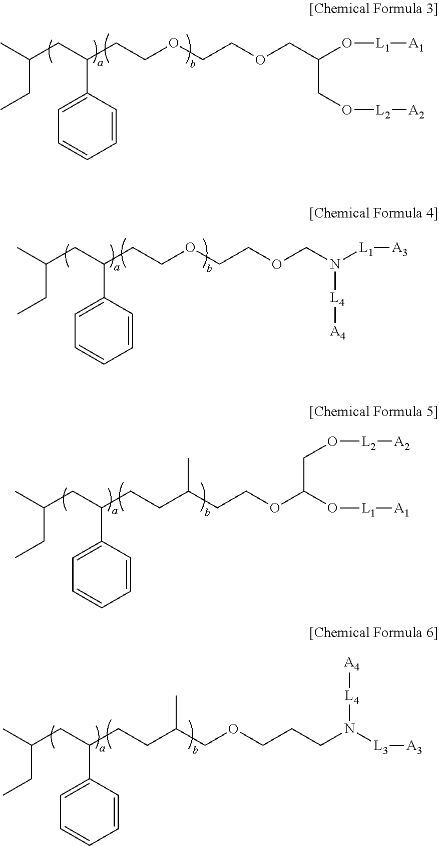

wherein
L₁ to L₄ are independently of one another C1-C7 alkylene;
A₁ to A₄ are independently of one another nitrile or

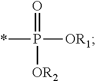

R₁ and R₂ are independently of each other hydrogen or C1-C7 alkyl; and
a and b are the number of repeating units of the block and independently of each other an integer of 10 or more.

The block copolymer to which the double terminal substituent is introduced according to an exemplary embodiment may be represented by the following Chemical Formula 11:

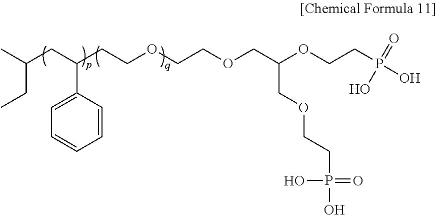

wherein
p and q are the number of repeating units of each block; and
a ratio (p:q) of the molecular weight of each block is 1:0.9 to 1.1.

The block copolymer to which the double terminal substituent is introduced according to an exemplary embodiment may be represented by the following Chemical Formulae 12 to 15:

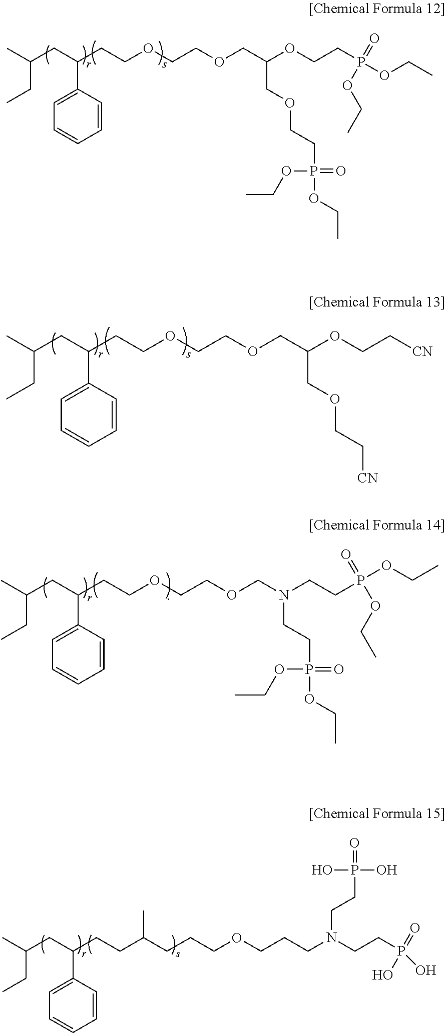

wherein
r and s are the number of repeating units of each block; and
a ratio (r:s) of the molecular weight of each block is 1:0.5 to 0.7.

The block copolymer of Chemical Formula 11 to which the double terminal substituent is introduced may form a plumber's nightmare structure (6-fold).

The block copolymers of Chemical Formula 12 to 14 to which the double terminal substituent is introduced may form a plumber's nightmare structure (6-fold).

The block copolymer of Chemical Formula 15 to which the double terminal substituent is introduced may form a diamond structure (4-fold).

In another general aspect, a self-assembly nanostructure prepared from the composition for forming a 4 or more-fold network structure is provided.

In still another general aspect, a method for controlling a self-assembly structure includes: introducing a double terminal substituent selected from the following Chemical Formulae 1 and 2 to a block copolymer terminal to adjust a network structure by self-assembly of a block copolymer:

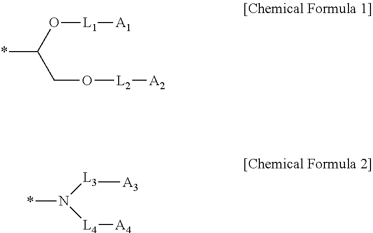

L₁ to L₄ are independently of one another C1-C7 alkylene;
A₁ to A₄ are independently of one another nitrile or

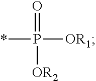

and
R₁ and R₂ are independently of each other hydrogen or C1-C7 alkyl.

The block copolymer may be a diblock copolymer including a first block having physical properties of glass and a second block having physical properties of rubber.

The block copolymer may have a number average molecular weight of 7.0 to 30.0 kg/mol and each block of the block copolymer may have a number average molecular weight of 3.0 kg/mol or more, respectively.

The method for controlling a self-assembly structure according to an exemplary embodiment may adjust the network structure of the block copolymer by selecting number average molecular weights of the first block and the second block and a double terminal substituent structure.

Other features and aspects will be apparent from the following detailed description, the drawings, and the claims.

### BRIEF DESCRIPTION OF THE DRAWINGS

FIGS. 1 to 3 show results of SAXS and WAXS analyses of Evaluation 1.

FIG. 4 shows results of TEMT and TEM analyses of Evaluation 2.

### DETAILED DESCRIPTION OF EMBODIMENTS

In the present specification, unless otherwise defined, all technical terms and scientific terms have the same meanings as those commonly understood by a person skilled in the art to which the present invention pertains. The terms used herein are only for effectively describing a certain specific example and are not intended to limit the present invention.

The singular form used in the present specification may be intended to also include a plural form, unless otherwise indicated in the context.

Throughout the present specification, unless otherwise particularly stated, the word “comprise”, “equipped”, “contain”, or “have” does not mean the exclusion of any other constituent element, but means further inclusion of other constituent elements, and elements, materials, or processes which are not further listed are not excluded.

The numerical range used in the present specification includes all values within the range including the lower limit and the upper limit, increments logically derived from the form and spanning of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

Unless otherwise particularly defined in the present specification, “about” may be considered as a value within 30%, 25%, 20%, 158, 10%, or 5% of a stated value.

Hereinafter, the present disclosure will be described in detail. However, it is only illustrative and the present disclosure is not limited to the specific exemplary embodiment which is illustratively described.

An exemplary embodiment of the present invention provides a composition for forming a 4 or more-fold network structure which is difficult to exist in a thermodynamically stable state.

Specifically, the composition for forming a 4 or more-fold network structure according to an exemplary embodiment may include a block copolymer to the terminal of which a double terminal substituent is introduced:

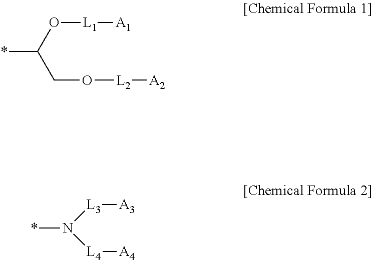

wherein
L₁ to L₄ are independently of one another C1-C7 alkylene;
A₁ to A₄ are independently of one another nitrile or

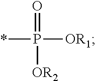

and
R₁ and R₂ are independently of each other hydrogen or C1-C7 alkyl.

According to an exemplary embodiment, a 4 or more-fold network structure in a stable state, for example, a diamond structure (4-fold), a plumber's nightmare structure (6-fold), or an A15 network structure (12, 14-fold) may be derived by introducing a double terminal substituent of a specific structure represented by Chemical Formulae 1 and 2 to a block copolymer terminal, and the composition for forming a 4 or more-fold network structure according to an exemplary embodiment may be a composition for forming a 4-fold or 6-fold network structure.

As an example, L₁ and L₂ may be independently of each other C1-C4 alkylene, and R₁ and R₂ may be independently of each other hydrogen or C1-C4 alkyl.

As an example, L₁ and L₂ may be identical to each other, and C1-C4 alkylene, C1-C3 alkylene, or ethyl.

As an example, R₁ and R₂ may be identical to each other, and hydrogen or C1-C4 alkyl, or hydrogen or ethyl.

The double terminal substituent according to an exemplary embodiment may be selected from the following structures, but is not necessarily limited thereto:

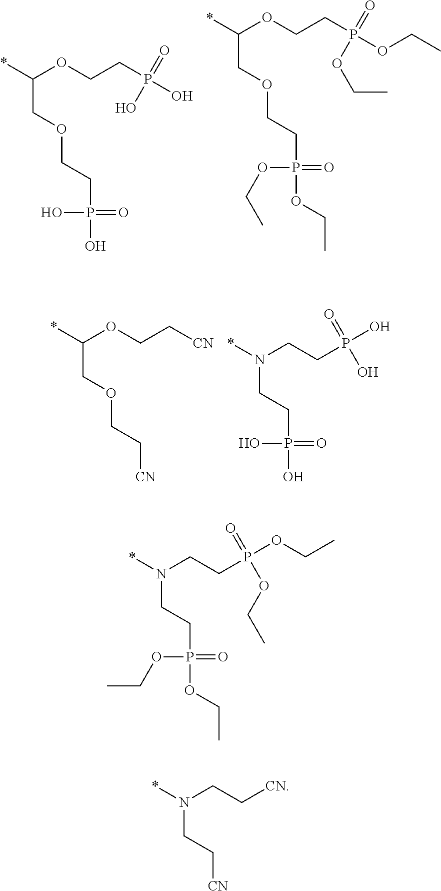

The block copolymer according to an exemplary embodiment may be a diblock copolymer including a first block having physical properties of glass and a second block having physical properties of rubber.

Herein, the physical properties of glass mean having a higher glass transition temperature, and specifically, may mean having a glass transition temperature of 20° C. or higher, 30° C. or higher, 50° C. or higher and 300° C. or lower, 250° C. or lower, or 200° C. or lower. The physical properties of rubber mean having a lower glass transition temperature, and may mean having a glass transition temperature of 30° C. or lower, 20° C. or lower, 10° C. or lower, 0° C. or lower and −200° C. or higher, −150° C. or higher, or −100° C. or higher.

The first block having physical properties of glass may be, as an example, selected from polystyrene, polyvinylpyridine, and the like.

The second block having physical properties of rubber may be, as an example, selected from polyethylene oxide, polymethylbutylene, polydimethylsiloxane, and the like.

The block copolymer may be, as an example, polystyrene-b-polyethylene oxide, polystyrene-b-polymethylbutylene, or polystyrene-b-polydimethylsiloxane.

Specifically, the block copolymer to which the double terminal substituent is introduced according to an exemplary embodiment may be represented by the following Chemical Formulae 3 to 6:

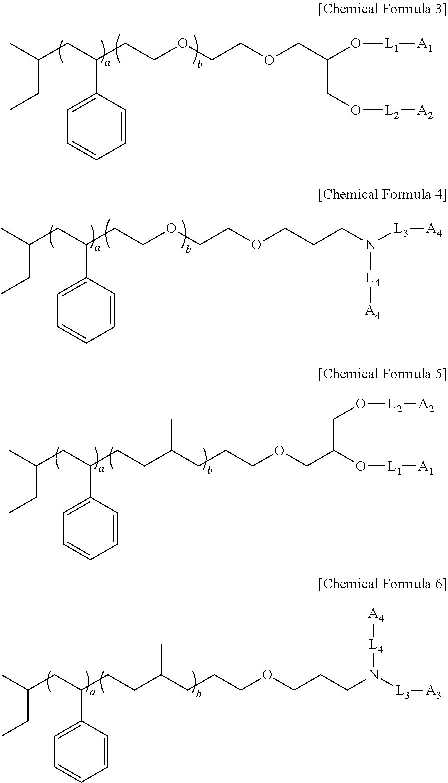

wherein
L₁ to L₄ are independently of one another C1-C7 alkylene;
A₁ to A₄ are independently of one another nitrile or

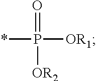

R₁ and R₂ are independently of each other hydrogen or C1-C7 alkyl; and
a and b are the number of repeating units of the block and independently of each other an integer of 10 or more.

As an example, a and b may be independently of each other 10 or more, 20 or more, 30 or more, 40 or more, 50 or more, 60 or more, or 70 or more and 300 or less, 250 or less, 200 or less, 150 or less, 100 or less, or 75 or less, and may include any possible combination of the upper limit and the lower limit.

The block copolymer according to an exemplary embodiment may have a number average molecular weight of 6.0 kg/mol or more, 6.7 kg/mol or more, 7.0 kg/mol or more, or 10 kg/mol or more and 50 kg/mol or less, 40 kg/mol or less, or 30 kg/mol or less, and specifically, 6.0 to 30 kg/mol, 6.0 to 24 kg/mol, 6.0 to 14.0 kg/mol, 7.0 to 30 kg/mol, 7.0 to 24 kg/mol, 7.0 to 20 kg/mol, 7.0 to 14.9 kg/mol, or 14.0 to 24.0 kg/mol. In addition, each block of the block copolymer may have a number average molecular weight of 3.0 kg/mol or more, 3.5 kg/mol or more, 4.0 kg/mol or more, 5.0 kg/mol or more, or 7.0 kg/mol or more and 25 kg/mol or less, 20 kg/mol or less, 15 kg/mol or less, or 10 kg/mol or less, respectively. Herein, the molecular weight of the block copolymer was analyzed using 1H nuclear magnetic resonance NMR, Bruker AVB00) and size exclusion chromatography (SEC, Waters Breeze 2 HPLC, THE solvent).

The block copolymer to which the double terminal substituent is introduced according to an exemplary embodiment may be represented by the following Chemical Formula 11:

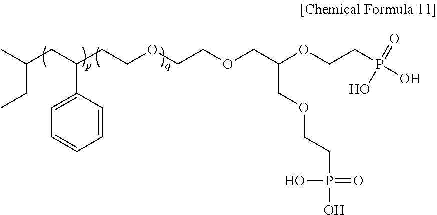

wherein
p and q are the number of repeating units of each block; and
a ratio (p:q) of the molecular weight of each block is 1:0.9 to 1.1.

Herein, the molecular weight of each block refers to a product of the number of repeating units of each block and the molecular weight of the repeating units (p*104.05, q*44.05).

In addition, the block copolymer to which the double terminal substituent is introduced according to an exemplary embodiment may be represented by the following Chemical Formulae 12 to 15:

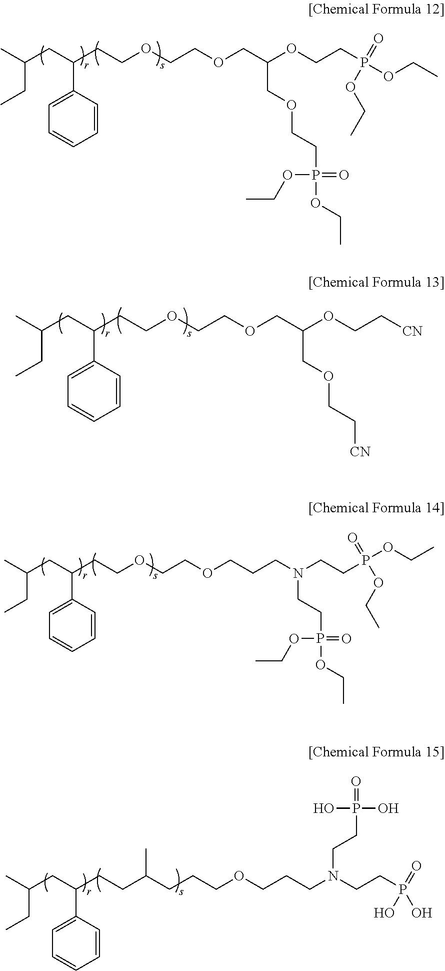

wherein
r and s are the number of repeating units of each block; and
a ratio (r:s) of the molecular weight of each block is 1:0.5 to 0.7.

Herein, the molecular weight of each block refers to a product of the number of repeating units of each block and the molecular weight of the repeating units (r*104.05, s*44.05, s*70.12).

The composition for forming a 4 or more-fold network structure including the block copolymer of Chemical Formula 11 to which the double terminal substituent is introduced may form the plumber's nightmare structure (6-fold).

The composition for forming a 4 or more-fold network structure including the block copolymer selected from Chemical Formulae 12 to 14 to which the double terminal substituent is introduced may form the plumber's nightmare structure (6-fold).

The composition for forming a 4 or more-fold network structure including the block copolymer of Chemical Formula 15 to which the double terminal substituent is introduced may form the diamond structure (4-fold).

Another exemplary embodiment of the present invention provides a self-assembly nanostructure prepared from the composition for forming a 4 or more-fold network structure.

Another exemplary embodiment of the present invention provides a method for controlling a self-assembly structure including: introducing a double terminal substituent selected from the following Chemical Formulae 1 and 2 to a block copolymer terminal to adjust a network structure by self-assembly of a block copolymer:

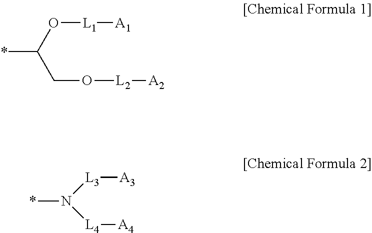

wherein
L₁ to L₄ are independently of one another C1-C7 alkylene;
A₁ to A₄ are independently of one another nitrile or

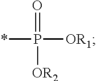

and
R₁ and R₂ are independently of each other hydrogen or C1-C7 alkyl.

The block copolymer may be a diblock copolymer including a first block having physical properties of glass and a second block having physical properties of rubber.

The method for controlling a self-assembly structure according to an exemplary embodiment may adjust the network structure of the block copolymer by selecting the number average molecular weights of the first block and the second block and a double terminal substituent structure, and may derive a 4 or more-fold network structure, for example, a diamond structure (4-fold), a plumber's nightmare structure (6-fold), or an A15 network structure (12, 14-fold).

Hereinafter, the exemplary embodiments described above will be described in detail through the following examples. However, the following examples are only for description, and do not limit the right scope.

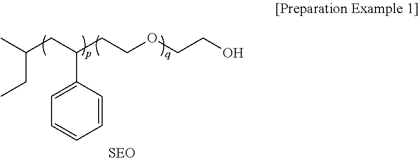

Polystyrene-b-polyethylene oxide (PS-b-PEO, SEO) was prepared by sequential anionic polymerization of styrene (10.5 ml) and ethylene oxide (11.0 ml). First, styrene was polymerized using sec-BuLi as an initiator (1.3 ml) in anhydrous benzene at 40° C. After 4 hours of the reaction, a small amount of ethylene oxide was added to prepare hydroxyl group (OH)-terminated polystyrene. Thereafter, ethylene oxide gas was added to the reactor under vacuum, a tert-BuP₄ catalyst (1.96 ml) was further added, polymerization was performed at 45° C. for 3 days, and then methanol and hydrochloric acid were added to end the reaction. Thereafter, impurities were removed using distilled water and dichloromethane (DCM) and extraction was performed. Deposition was performed 3 times in n-hexane and diethyl ether, respectively, purification was performed, and drying was performed for 2 hours to obtain SEO of 7.5-b-7.4 kg/mol (Mₙ=7.5-b-7.4 kg/mol, PDI=1.05, f_{PEO}=0.50).

Herein, f_{PEO} refers to a volume fraction of PEO, and the volume fraction of PEO was calculated by determining the volume of each block by dividing the molecular weight of each block by the density of each block.

### [Preparation Example 2]

SEO of 14.5-b-9.5 kg/mol was obtained in the same manner as in Preparation Example 1, except that the amounts of styrene and ethylene oxide used were changed to 6.0 ml and 6.4 ml, respectively (Mₙ=14.5-b-9.5 kg/mol, PDI=1.05, f_{PEO}=0.38).

### [Preparation Example 3]

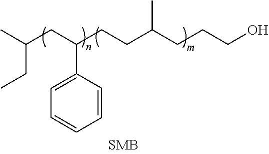

Polystyrene-b-polymethylbutylene (PS-b-PMB, SMB) was prepared by sequential anionic polymerization of styrene (14.1 ml) and isoprene (10.5 ml). First, styrene was polymerized using sec-BuLi as an initiator (1.3 ml) in anhydrous cyclohexane at 40° C. After 4 hours of the reaction, isoprene was added under vacuum, and polymerization was performed for 4 hours under the same temperature conditions. Thereafter, purification was performed by repetitive precipitation and vacuum drying and selective hydrogenation of isoprene was performed to obtain SMB of 9-b-5 kg/mol (Mₙ=9.0-b-5.0 kg/mol, PDI=1.04, f_{PMB}=0.40).

<Preparation of Block Copolymer to which Double Terminal Substituent was Introduced>

### Example 1

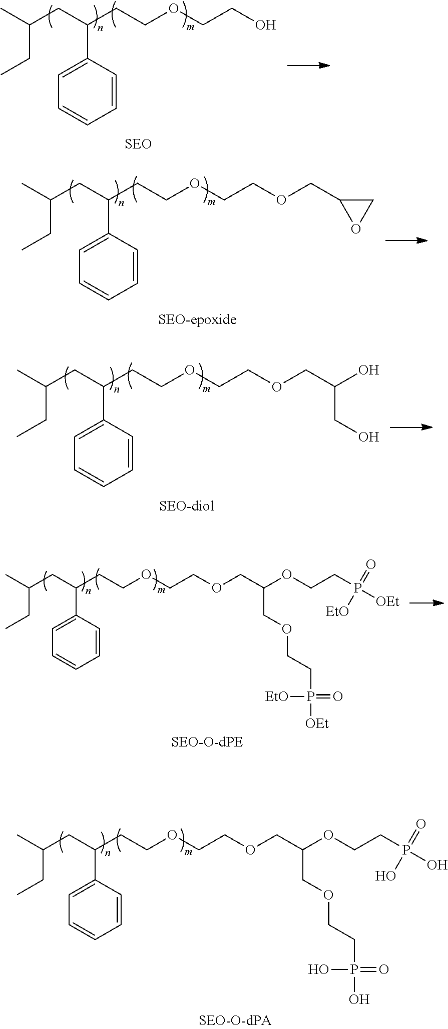

SEO-epoxide, SEO-diol, SEO-O-dPE, and SEO-O-dPA having f_{PEO}=0.50 were sequentially obtained using SEO of 7.5-b-7.4 kg/mol (f_{PEO}=0.50) obtained in Preparation Example 1.

### Step 1: Epoxide Terminal SEO(SEO-Epoxide)

SEO of 7.5-b-7.4 kg/mol (1.5 g, 0.1 mmol) obtained in Preparation Example 1 was dissolved in 5 ml of anhydrous tetrahydrofuran (THF), and NaH (5 mg, 0.21 mmol) was added under argon. The mixture was stirred at 30° C. for 2 hours, epichlorohydrin (1 mL, 12.7 mmol) was gradually added, and the reaction was further performed for 48 hours. Thereafter, the reaction mixture was extracted using distilled water/DCM to obtain an organic phase, which was then dried using NaSO₄, filtered under reduced pressure, concentrated using a rotary evaporator, and precipitated in cold diethyl ether to obtain a white solid. The product was dried under vacuum to obtain epoxide terminal SEO(SEO-epoxide).

¹H NMR (300 MHZ, CDCl₃) δH ppm: 7.24-6.28 (br, n×5H, —CH₂CH(C₆H₅)), (br, m×4H, —OCH₂CH₂O—), 3.15 (m, 1H, CHOCH₂), 2.78 (d, 1H, CH₂OCH), 2.61 (d, 1H, CH₂OCH), 2.24-1.22 (br, n×3H, —CH₂CH(C₆H₅)).

### Step 2: Diol Terminal SEO(SEO-Diol)

SEO-epoxide (1.5 g, 0.1 mmol) obtained above was dissolved in distilled water/dimethylformamide (DMF) solution (5 mL, 50/50 vol/vol). Thereafter, the temperature was raised to 110° C., stirring was performed for 20 hours, concentration was performed using a rotary evaporator, precipitation was performed in cold diethyl ether to obtain a white solid, which was dried under vacuum to obtain diol terminal SEO(SEO-diol).

¹H NMR (300 MHZ, CDCl₃) δH ppm: 7.10-6.40 (br, n×5H, —CH₂CH(C₆H₅)), 3.62 (br, m×4H, —OCH₂CH₂O—), 2.21-1.20 (br, n×3H, —CH₂CH(C₆H₅)).

### Step 3: O-dPE Terminal SEO(SEO-O-dPE)

SEO-diol (0.75 g, 0.05 mmol) obtained above was dissolved in acetonitrile (ACN) (3 ml), CsCO₃ (20 mg, 0.06 mmol) was added, and stirring was performed at 80° C. for 1 hour. Thereafter, diethyl vinylphosphonate (2 mL, 13 mmol) was added, a reflux reaction was performed for 72 hours, a 1M HCl solution (0.2 mL) was added, extraction was performed with DCM to obtain an organic phase, which was dried with Na₂SO₄, filtered, concentrated, and precipitated in diethyl ether to obtain a white solid. The obtained solid was dried under vacuum to obtain a di-phosphonic acid ethyl ester (dPE) terminal SEO(SEO-O-dPE) linked by an ether linker (—O—).

¹H NMR (500 MHZ, THF-d₈ and MeOD (5:1)) δH (ppm): 7.30-6.30 (br, n×5H, —CH₂CH(CH₅)), 4.05 (m, 8H, P═O(OCH₂CH₃)₂), 3.62 (br, m×4H, —OCH₂CH₂O—), 2.26 (m, 4H, —PCH₂CH₂O—), 1.27 (12H, —P═O(OCH₂CH₃)₂), 2.21-1.20 (br, n×3H, —CH₂CH(C₆H₅)).

³¹P NMR (203 MHZ, THF-d₈ and MeOD (5:1)) δP (ppm): 31.03, 30.84.

### Step 4: O-dPA Terminal SEO(SEO-O-dPA)

SEO-O-dPE (0.75 g, 0.05 mmol) obtained above was dissolved in anhydrous chloroform (5 ml) and cooled to 0° C. under an argon atmosphere, and bromotrimethylsilane (0.1 mL, 0.75 mmol) was slowly added. The reaction mixture was stirred at 40° C. for 24 hours, and argon was blown thereinto to remove the solvent. Thereafter, the reaction was ended with excessive methanol, stirring was performed at room temperature for 4 hours, concentration was performed using a rotary evaporator, and precipitation was performed in cold diethyl ether to obtain a solid. The obtained solid was dried under vacuum to obtain a di-phosphonic acid (dPA) terminal SEO(SEO-O-dPA) linked by an ether linker (—O—).

¹H NMR (500 MHZ, THF-d₈ and MeOD (5:1)) δ ppm: 7.30-6.30 (br, n×H, —CH₂CH(C₆H₅)), 3.62 (br, m×4H, —OCH₂CH₂O—), 2.26 (m, 4H, —PCH₂CH₂O—), 2.21-1.20 (br, n×3H, —CH₂CH(C₆H₅)).

³¹P NMR (203 MHZ, THE-d₈ and MeOD (5:1)) δP (ppm): 23.57, 22.74

### Example 2

SEO-diol, SEO-O-dPE, and SEO-O-dPA having f_{PEO}=0.38% were obtained in the same manner as in Example 1, except that 14.5-b-9.5 kg/mol SEO(f_{PEO}=0.38) of Preparation Example was used as the block copolymer instead of SEO of Preparation Example 1.

### Example 3

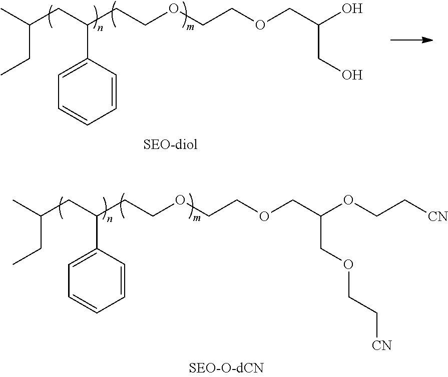

SEO-diol (2.4 g, 0.1 mmol) obtained in Example 2 was dissolved in 20 ml of ACN and then cooled to 0° C. Thereafter, KOH (20 mg, 0.36 mmol) was added, stirring was performed at 0° C. for 6 hours, and then a small amount of 1 M HCl was added. The reaction mixture was extracted with distilled water/DCM to obtain an organic phase, which was dried with Na₂SO₄, filtered, concentrated, and precipitated in diethyl ether to obtain a white solid. The obtained solid was dried under vacuum to obtain a di-nitrile (dCN) terminal SEO(SEO-O-dCN) linked by an ether linker (—O—).

¹H NMR (500 MHZ, THF-d₈) δH ppm: 7.10-6.40 (br, n×5H, —CH₂CH(C₆H₅)), 3.75 (t, 2H, —CH₂CH₂CN), 3.62 (br, m×4H, —OCH₂CH₂O—), 2.60 (t, 2H, —CH₂CH₂CN), 2.29-1.25 (br, (n×3H, —CH₂CH(C₆H₅)).

### Example 4

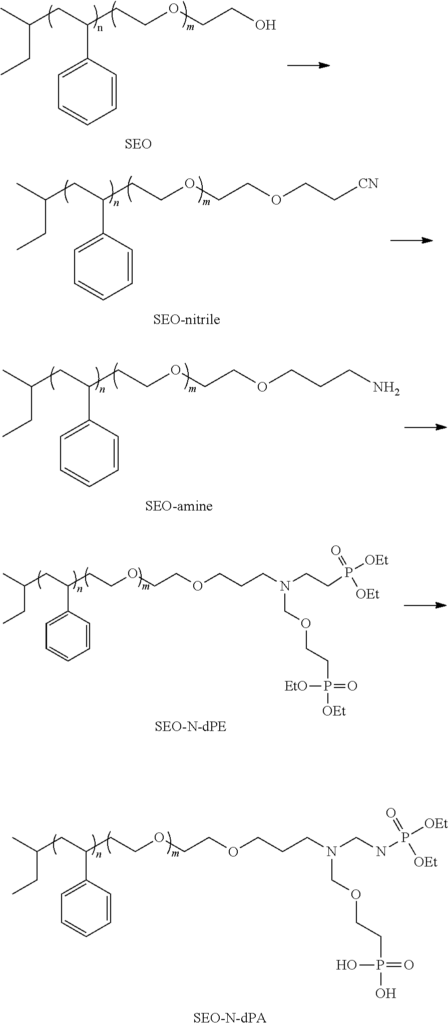

SEO-amine, SEO-N-dPE, and SEO-N-dPA having f_{PEO}=0.38% were sequentially obtained, using 14.5-b-9.5 kg/mol SEO (f_{PEO}=0.38) of Preparation Example 2.

### Step 1: Nitrile Terminal SEO(SEO-Nitrile)

14.5-b-9.5 kg/mol SEO(2.4 g, 0.1 mmol) obtained in Preparation Example 2 was dissolved in 20 ml of ACN, KOH (20 mg, 0.36 mmol) was added, and cooling to 0° C. was performed. Thereafter, stirring was performed at 0° C. for 2.5 hours, and a small amount of 1 M HCl was added to end the reaction. The reaction mixture was extracted with distilled water/DCM to obtain an organic phase, which was dried with Na₂SO₄, filtered, concentrated, and precipitated in diethyl ether to obtain a white solid, which was dried to obtain nitrile terminal SEO(SEO-nitrile).

¹H NMR (300 MHZ, CDCl₃) δH ppm: 7.10-6.40 (br, n×5H, —CH₂CH(C₆H₅)), 3.75 (t, 2H, —CH₂CH₂CN), 3.62 (br, m×4H, —OCH₂CH₂O—), 2.65 (t, 2H, —CH₂CH₂CN), 2.29-1.25 (br, n×3H, —CH₂CH(C₆H₅)).

### Step 2: Amine Terminal SEO(SEO-Amine)

SEO-nitrile (2.4 g, 0.1 mmol) obtained above was dissolved in anhydrous THF (12 ml), and the solution was gradually added to a 1 M borane-THE complex solution (4 mL) at 0° C. The reaction mixture was stirred at 0° C. for 30 minutes, and was reflux reacted at 75° C. Thereafter, cooling to 0° C. was performed, methanol (5 ml) was added, and then a small amount of 1 M HCl was added. The mixture was further stirred for 1 hour, and co-evaporation was performed with methanol to remove trimethyl borate. A NaOH solution was added to the residue, and extraction was performed with distilled water/DCM to obtain an organic phase, which was filtered, concentrated, and dried under vacuum to obtain amine terminal SEO(SEO-amine).

¹H NMR (300 MHZ, CDCl₃) δH (ppm): 7.10-6.40 (br, n×5H, —CH₂CH(C₆H₅)), 3.62 (br, m×4H, —OCH₂CH₂O—), 2.88 (t, 2H, —CH₂CH₂NH₂), 1.83 (t, 2H, —OCH₂CH₂CH₂—), 2.21-1.20 (br, n×3H, —CH₂CH(C₆H₅)).

### Step 3: N-dPE Terminal SEO(SEO-N-dPE)

The amine terminal SEO(SEO-amine) (1.2 g, 0.05 mmol) obtained above was dissolved in distilled water/THF (20 mL, 50/50 vol/vol), and diethyl vinylphosphonate (2 mL, 13 mmol) was added. The reaction mixture was stirred at 60° C. for 72 hours, concentrated using a rotary evaporator, precipitated in diethyl ether, and dried under vacuum to obtain di-phosphonic acid ethyl ester (dPE) terminal SEO(SEO-N-dPE) linked by an amine linker (—N).

¹H NMR (500 MHZ, THE-d₈ and MeOD (5:1)) δH (ppm): 7.30-6.30 (br, n×5H, —CH₂CH(C₆H₅)), 4.02 (m, 8H, —P═O(OCH₂CH₃)₂), 3.62 (br, m×4H, —OCH₂CH₂O—), 2.73 (m, 4H, —NCH₂CH₂—), 2.50 (m, 2H, —CH₂CH₂N—), 2.09 (m, 4H, —NCH₂CH₂—), 1.65 (m, 2H, —OCH₂CH₂CH₂—), 1.27 (m, 12H, —P═O(OCH₂CH₃)₂), 2.21-1.20 (br, n×3H, —CH₂CH(C₆H₅)).

³¹P NMR (203 MHZ, THE-d₈ and MeOD (5:1)) δP (ppm): 31.14

### Step 4: N-dPA Terminal SEO(SEO-N-dPA)

SEO-N-dPE (0.84 g, 0.035 mmol) obtained above was dissolved in anhydrous chloroform (5 ml) under an argon atmosphere and cooled to 0° C., and bromotrimethylsilane (0.1 mL, 0.75 mmol) was slowly added. The reaction mixture was stirred at 40° C. for 24 hours, and argon was blown thereinto to remove the solvent. Thereafter, the reaction was terminated with excessive methanol, stirring was performed at room temperature for 4 hours, and extraction was performed with distilled water/DCM to obtain an organic phase, which was dried with Na₂SO₄, filtered, concentrated, and precipitated in diethyl ether to obtain a white solid. The obtained solid was dried under vacuum to obtain a di-phosphonic acid (dPA) terminal SEO(SEO-N-dPA) linked by an amine linker (—N—).

¹H NMR (500 MHZ, THF-d₈ and MeOD (5:1)) δH (ppm): 7.10-6.40 (br, n×5H, —CH₂CH(C₆H₅)), 3.62 (br, m×4H, —OCH₂CH₂O—), 3.44 (m, 4H, —NCH₂CH₂—), 3.31 (m, 2H, —CH₂CH₂N—), 2.04 (m, 6H, —CH₂CH₂NCH₂CH₂—), 2.21-1.20 (br, n×3H, —CH₂CH(C₆H₅)).

³¹P NMR (203 MHZ, THF-d₈ and MeOD (5:1)) δP (ppm): 17.72.

### Example 5

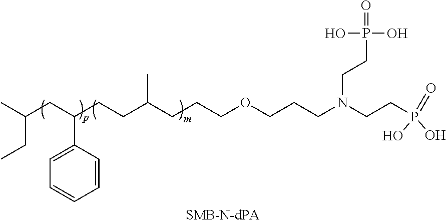

SMB-amine, SMB-N-dPE, and SMB-N-dPA were sequentially obtained in the same manner as in Example 4, except that 9-b-5 kg/mol of SMB of Preparation Example 3 was used as the block copolymer instead of 14.5-b-9.5 kg/mol of SEO of Preparation Example 2.

SMB-N-dPA: ¹H NMR (500 MHZ, CDCl₃) δH ppm: 7.26-6.31 (br, n×5H, —CH₂CH(C₆H₅)), 3.67 (m, 4H, —CH₂OCH₂—), 3.53 (m, 4H, —NCH₂CH₂—), 3.42 (m, 2H, —CH₂CH₂N—), 2.15 (m, 6H, —CH₂CH₂NCH₂CH₂—), 2.24-1.18 (br, n×3H, —CH₂CH(C₆H₅)), 1.34-1.47 (br, m×1H, —CH₂CH₂CH(CH₃)CH₂—) 1.18-1.34 (br, m×4H, —CH₂CH₂CH(CH₃) CH₂—), 0.99-1.18 (br, m×2H, —CH₂CH₂CH(CH₃)CH₂—), 0.82-0.91 (br, m×3H, CH₂CH(CH₃) CH₂—).

³¹P NMR (203 MHZ, THF-d₈ and MeOD (10:1)) δP (ppm): 18.95.

### <Evaluation Example> Morphology Analysis

### Evaluation 1. SAXS and WAXS Analyses

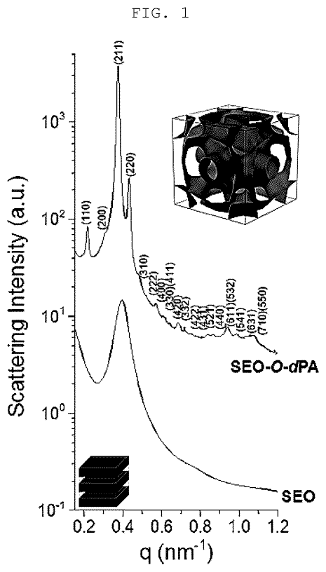

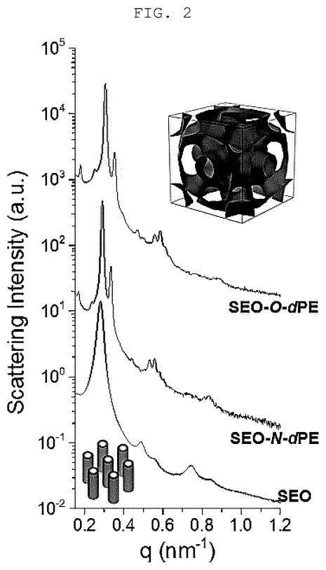

Small angle X-ray scattering (SAXS) was performed to analyze the structures of the block copolymers of Preparation Example 1 (SEO, FIG. 1), Preparation Example 2 (SEO, FIG. 2), and Preparation Example 3 (SMB, FIG. 3), and wide angle X-ray scattering (WAXS) was performed to analyze the structures of the block copolymers to which the double terminal substituent was introduced obtained in Example 1 (SEO-O-dPA, FIG. 1), Example 2 (SEO-O-dPE, FIG. 2), Example 4 (SEO-N-dPE, FIG. 2), and Example 5 (SMB-N-dPA, FIG. 3). The SAXS measurement was performed in PLS-II 3C, 4C, 9A beam lines (λ=0.628 Å, Δλ/λ=10⁻⁴), and a cell closed by a Kapton film was manufactured and used. In order to cover a wide range of scattering wave vector (q=4π sin (θ/2)/λ, wherein θ is a scattering angle), two different sample-detector distances of 4 m and 2 m were used, and in order to search a chain structure of the block copolymer having a double terminal, a WAXS experiment was performed, which was also performed using a sample-detector distance of 20 cm in a PLS-II 9A bean line, and the results are shown in FIGS. 1 to 3.

Referring to FIGS. 1 to 3, though the block copolymers to which the double terminal substituent was not introduced obtained in Preparation Examples 1 to 3 showed a lamella or cylinder structure, respectively, a 4 or more-fold network structure was observed in all of the block copolymers to which the double terminal substituent was introduced of the examples. Specifically, SEO-O-dPA of Example 1, SEO-O-dPE of Example 2, and SEO-N-dPE of Example 4 showed peaks corresponding to (110), (200), (211), (220), (310), (321), (400), (411), (420), (332), (422), (431), (521), (440), (611), (541), (631), and (710) planes, which means a plumber's nightmare structure (Im3m structure) in the form in which 6 channels intersect (6-fold), and SMB-N-dPA of Example 5 showed peaks corresponding to (110), (111), (200), (211), (220), (310), (222), (321), (400), (322), (411), (422), (510), (521), and (530) planes, from which a diamond structure (Pn3m) in the form in which 4 channels intersect (4-fold) was observed. In addition, it was confirmed that a 6-fold structure was observed in SEO-0-dCN of Example 3.

That is, it was confirmed that the block copolymer according to an exemplary embodiment of the present invention may implement a thermodynamically stable 4 or more-fold network structure simply by introducing a double terminal substituent.

### Evaluation 2. TEMT and TEM Analyses

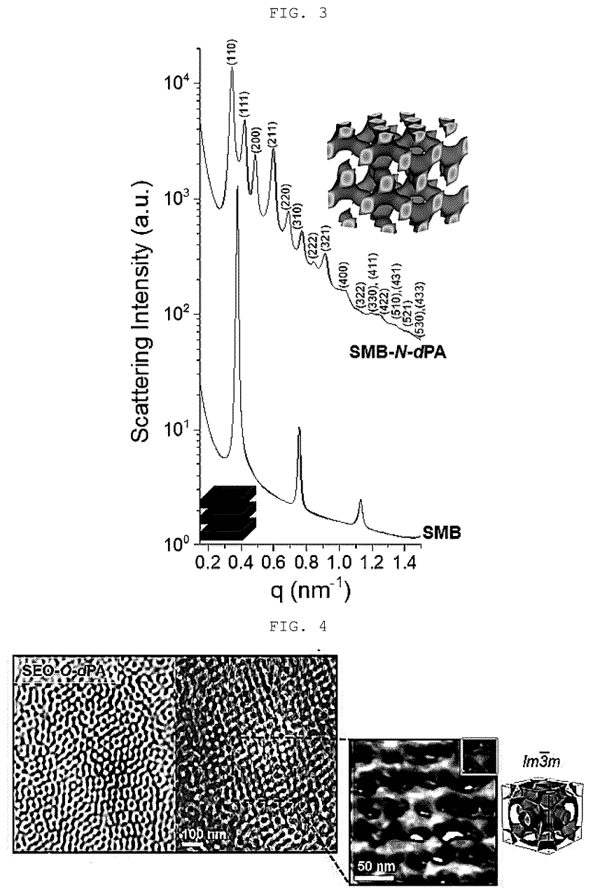

In order to directly visualize the Im3m structure of SEO-O-dPA of Example 1, transmission electron microscopy tomography (TEMT) and transmission electron microscopy (TEM) analyses were performed, and the results are shown in FIG. 4.

Specifically, SEO-O-dPA of Example 1 was cyto-microtomed (RMC Boeckeler PT XL ultramicrotome) at −120° to obtain a thin sample having a thickness of about 100 nm. The sample was transferred to a copper grid, and exposed to ruthenium tetraoxide (RuO₄) steam for 30 minutes in order to selectively dye a PEO domain. A TEM image was obtained from JEM-2200FS (JEOL Ltd.) equipped with a Cs-correction device operated at 200 kV, and visualized using a Digital Micrograph software (Gatan Inc.). A TEMT image for SEO-O-dPA was analyzed in JEM-1400 operated at 120 kV. The current density of the electron beam was maintained at 5.6 pA cm⁻², and the tilt series of the TEM image was analyzed by exposure for 1 second using a 2048×2048 pixel Xarosa lower mounted CMOS camera (EMSIS GmbH)

It was confirmed that the SEO-O-dPA of Example 1 had a thermodynamically stable Im3m structure as shown in FIG. 4. A 6-fold structure in which 6 channels gathered in one node was clearly shown, and the domain size was also confirmed to be matched the size obtained in the SAXS experiment.

The composition for forming a 4 or more-fold network structure according to an exemplary embodiment of the present invention may implement a 4 or more-fold network structure in a thermodynamically stable state, for example, a diamond structure (Pn3M structure) in the form in which 4 channels intersect (4-fold) or a plumber's nightmare structure (Im3m structure) in the form in which 6 channels intersect (6-fold). Specifically, in the conventional technology, a complicated network structure in the form in which multiple channels intersect has a limitation in that it is difficult to exist in a stable state, but according to an exemplary embodiment, a diamond or plumber's nightmare structure in the stable state may be derived simply by introducing a double terminal substituent having a specific structure to a block copolymer.

In addition, according to an exemplary embodiment, since a sophisticated control technology, a complicated synthesis process, and the like are not required for implementing the 4 or more-fold network structure, the present invention is expected to have excellent processability and economic feasibility and be usefully applied to various industrial sites.

Hereinabove, although the present invention has been described by specific exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modifications equal or equivalent to the claims are intended to fall within the scope and spirit of the invention.

What is claimed is:

1. A composition for forming a 4 or more-fold network structure comprising a block copolymer to the terminal of which a double terminal substituent selected from the following Chemical Formulae 1 and 2 is introduced: 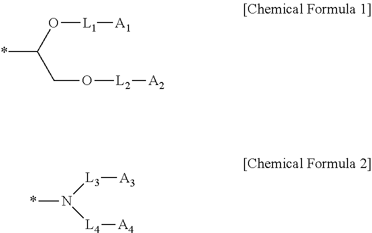
wherein
L₁ to L₄ are independently of one another C1-C7 alkylene;
A₁ to A₄ are independently of one another nitrile or 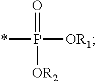
and
R₁ and R₂ are independently of each other hydrogen or C1-C7 alkyl.

2. The composition for forming a 4 or more-fold network structure of claim 1, wherein L₁ and L₂ are independently of each other C1-C4 alkylene, and R₁ and R₂ are independently of each other hydrogen or C1-C4 alkyl.

3. The composition for forming a 4 or more-fold network structure of claim 1, wherein the double terminal substituent is selected from the following structures:

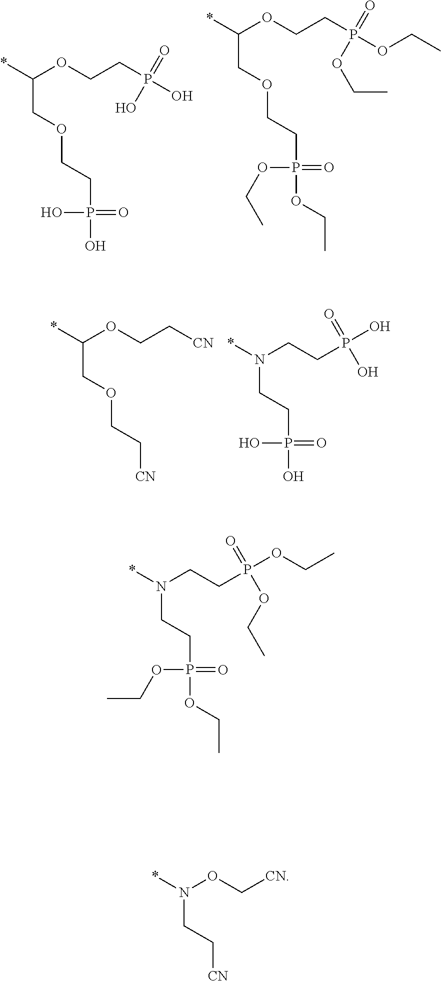

4. The composition for forming a 4 or more-fold network structure of claim 1, wherein the block copolymer is a diblock copolymer including a first block having physical properties of glass and a second block having physical properties of rubber.

5. The composition for forming a 4 or more-fold network structure of claim 4, wherein the block copolymer is polystyrene-b-polyethylene oxide, polystyrene-b-polymethylbutylene, or polystyrene-b-polydimethylsiloxane.

6. The composition for forming a 4 or more-fold network structure of claim 4, wherein the block copolymer has a number average molecular weight of 7.0 to 30 kg/mol, and each block of the block copolymer has a number average molecular weight of 3.0 kg/mol or more, respectively.

7. The composition for forming a 4 or more-fold network structure of claim 1, wherein the 4 or more-fold network structure is selected from a diamond structure (4-fold), a plumber's nightmare structure (6-fold), and an A15 network structure (12,14-fold).

8. The composition for forming a 4 or more-fold network structure of claim 1, wherein the block copolymer to which a double terminal substituent is introduced is represented by the following Chemical Formulae 3 to 6: 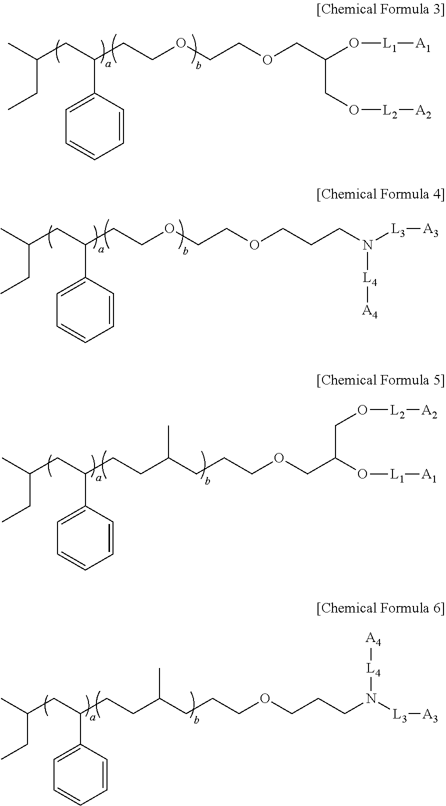
wherein
L₁ to L₄ are independently of one another C1-C7 alkylene;
A₁ to A₄ are independently of one another nitrile or 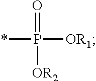
R₁ and R₂ are independently of each other hydrogen or C1-C7 alkyl; and
a and b are the number of repeating units of the block and independently of each other an integer of 10 or more.

9. The composition for forming a 4 or more-fold network structure of claim 6, wherein the block copolymer to which a double terminal substituent is introduced is represented by the following Chemical Formula 11: 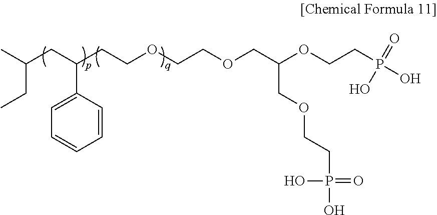
wherein
p and q are the number of repeating units of each block; and
a ratio (p:q) of the molecular weight of each block is 1:0.9 to 1.1.

10. The composition for forming a 4 or more-fold network structure of claim 6, wherein the block copolymer to which a double terminal substituent is introduced is represented by the following Chemical Formulae 12 to 15: 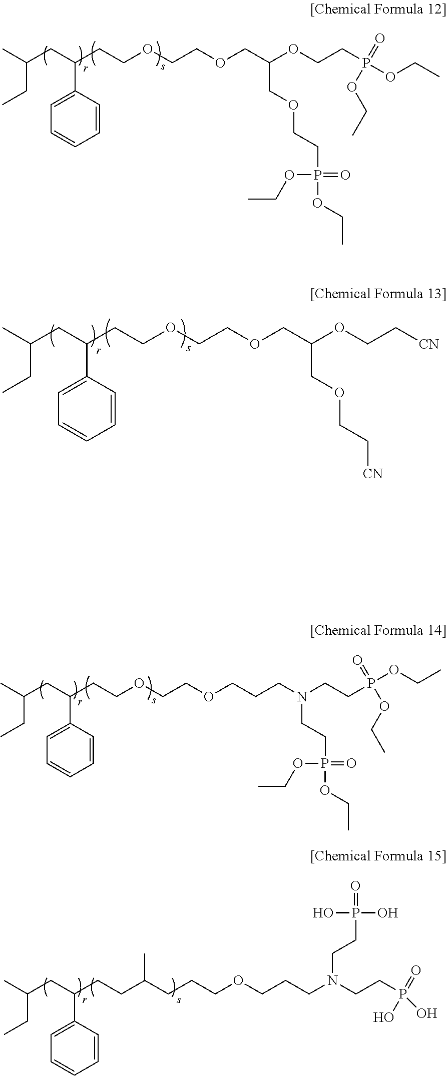
wherein
r and s are the number of repeating units of each block; and
a ratio (r:s) of the molecular weight of each block is 1:0.5 to 0.7.

11. The composition for forming a 4 or more-fold network structure of claim 9, wherein the block copolymer of Chemical Formula 11 to which the double terminal substituent is introduced forms a plumber's nightmare structure (6-fold).

12. The composition for forming a 4 or more-fold network structure of claim 10, wherein the block copolymers of Chemical Formulae 12 to 14 to which the double terminal substituent is introduced form a plumber's nightmare structure (6-fold).

13. The composition for forming a 4 or more-fold network structure of claim 10, wherein the block copolymer of Chemical Formula 15 to which the double terminal substituent is introduced forms a diamond structure (4-fold).

14. A self-assembly nanostructure prepared from the composition for forming a 4 or more-fold network structure of claim 1.

15. A method for controlling a self-assembly structure comprising: introducing a double terminal substituent selected from the following Chemical Formulae 1 and 2 to a block copolymer terminal to adjust a network structure by self-assembly of a block copolymer: 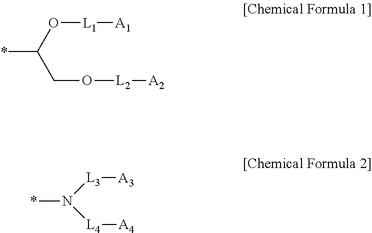
wherein
L₁ to L₄ are independently of one another C1-C7 alkylene;
A₁ to A₄ are independently of one another nitrile or 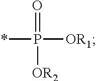
and
R₁ and R₂ are independently of each other hydrogen or C1-C7 alkyl.

16. The method for controlling a self-assembly structure of claim 15, wherein the block copolymer is a diblock copolymer including a first block having physical properties of glass and a second block having physical properties of rubber.

17. The method for controlling a self-assembly structure of claim 16, wherein the block copolymer has a number average molecular weight of 7.0 to 30.0 kg/mol and each block of the block copolymer has a number average molecular weight of 3.0 kg/mol or more, respectively.

18. The method for controlling a self-assembly structure of claim 17, wherein the network structure of the block copolymer is adjusted by selecting the number average molecular weights of the first block and the second block, and a double terminal substituent structure.
